(19) United States
(12) Patent Application Publication
(10) Pub. No.: US 2023/0211836 A1
(43) Pub. Date: Jul. 6, 2023

(54) Automatic Spare Tire Hoist

(71) Applicant: William G. Durbin, Tucson, AZ (US)

(72) Inventor: William G. Durbin, Tucson, AZ (US)

(21) Appl. No.: 17/566,896

(22) Filed: Dec. 31, 2021

(51) Int. Cl. B62D 43/04; B60R 16/033

(52) U.S. Cl. CPC B62D 43/045; B60R 16/033

(57) ABSTRACT

An article of manufacture for providing a leak resistant facemask according to the present invention is an automated accessory for a spare tire hoist for an automotive vehicle having a direct current power source and a spare tire stored in a horizontal orientation beneath the underside of a vehicle body and including a hoist with a rotatable drive input for raising and lowering said spare tire. The automated spare tire hoist includes a bidirectional direct current motor for mounting beneath said underside of the vehicle body proximate the spare tire hoist and having a motor output drive shaft and electrical input leads, speed reduction gearing coupled to the motor output drive shaft and having a gear output drive shaft, a coupler extending from the gear output drive shaft for engagement with said hoist drive input, a load-actuated circuit breaker coupled in circuit with the electrical input leads to said motor and having accessory power leads for connection to the direct current power source of the vehicle; and an actuating electrical switch coupled in circuit with the accessory power leads and located remotely from the motor for alternatively driving the motor in opposite directions and for cutting power to the motor entirely.

### CROSS-REFERENCE TO RELATED APPLICATION

This application claims priority to U.S. Patent Application No. 63/133,340, titled “Wireless Automatic Tire Winch,” and filed on Jan. 2, 2021. The entire application is incorporated herein by reference in its entirety.

### TECHNICAL FIELD

The present invention relates to an electrically powered control system for operating a spare tire hoist to lower and raise a spare tire stored beneath the undercarriage of a vehicle.

### BACKGROUND

In many heavier duty general purpose vehicles that are currently utilized, the vehicle spare tire, provided as basic equipment on nearly ail automotive vehicles, is stored beneath the undercarriage of the vehicle in a general\ horizontal disposition. Many pickup trucks, sport utility vehicles, vans, and other vehicles having sufficient ground clearance include an arrangement for storing the vehicle spare tire directly under the undercarriage, beneath the floor at the rear of the vehicle. Such a storage arrangement is advantageous In that the vehicle spare tire does not occupy valuable trunk m cargo storage space since it is located beneath the bed m rear floor of the vehicle. Furthermore, storage of the spare tire in this location also avoids the visual obstruction to the vehicle driver that exists when spare tire storage is on the rear door or tailgate of the vehicle. Also, storage of the vehicle spare tire beneath the rear deck of the vehicle avoids excessive weight on the hinges of a rear vehicle door that occurs when a spare tire is hung on a storage rack mounted on the outside of the vehicle door.

In a conventional spare tire storage system in which the spare tire is stored on the underside of the vehicle a hoist mechanism is supplied for raising and lowering the spare tire. This hoist mechanism is typically a manually operated system in which the spare tire jack handle, tire iron, or some other tool provided with the vehicle is employed to operate the hoist mechanism to lower and raise the spare tire. However. conventional systems of this type are difficult to operate, as they often require considerable physical strength on the part of the person attempting to take a spare tire out of its storage location or return it to that location.

Various electrically operated spare tire hoist control systems have been devised or use in raising and lowering a vehicle spare tire stored beneath the undercarriage of the vehicle. One such device Is described in U.S. Pat No. 4,613,273. In this system a tire winch is mounted underneath a vehicle, such as a truck, and Is operated by a winch driven by a reversible electric motor through a winch drive mechanism. A switch is employed to power the motor to operate the winch In either direction. The switch made be a key-operated switch located adjacent the spare tire assembly or may be a standard toggle-type switch mounted within the interior of the vehicle.

One significant problem with the arrangement disclosed in this prior patent Is that there is no safeguard against over winding the winch when raising the spare tire hack to its stored position. Unless the user is extremely careful, the spare tire can be brought up to its stored position from which it can be raised no further while the hoist motor is still being operated. If power is not cut off to the motor by operating the switch at the precise moment that the spare tire reaches its stored position, the motor will continue to operate to attempt to raise the spare tire-further. This can result in burnout of the winch motor 201, or the hoist cable can break. On the other hand, if power to the winch motor 201 is terminated too early when raising the spare tire back to its stored position. the spare tire will rattle against the underside of the vehicle when the vehicle is driven. Also. if the spare tire is not fully returned to its stored position, it can become detached from the hoist mechanism as the vehicle travels and drop to the road without the driver noticing that the spare tire has been lost.

Therefore, a need exists for an article of manufacture for providing a wireless automatic tire winch. The present invention attempts to address the limitations and deficiencies in prior solutions according to the principles and example embodiments disclosed herein.

### SUMMARY

In accordance with the present invention, the above and other problems are solved by providing an article of manufacture providing a wireless automatic tire winch according to the principles and example embodiments disclosed herein.

In one embodiment, the present invention is an article of manufacture for or providing a wireless automatic tire winch. The present invention provides an improved electrically operated system for raising and lowering a spare vehicle tire relative to a storage position located beneath the undercarriage or rear deck of the vehicle. The present invention provides a safeguard that ensures that the electric motor operating the hoist is shut off at precisely the proper time when raising the vehicle spare tire to its stored position beneath the vehicle. Specifically, the system of the present invention provides an electrical load-sensitive shut off device that is coupled in circuit with the electrical power inputs to the motor. As the spare tire is raised upwardly to the point at Which it meets the undersurface of the vehicle or some other structure that prevents it from being raised further, the motor pulling on the hoist cable is subjected to an increased load. This electrical load increase causes the amperage drawn by the motor to increase. The electrical load-sensitive shut off device that is located in circuit with the electric motor is thereupon activated and cuts off current to the motor. The load-sensitive shut off device may, for example, be a self-resetting circuit breaker, such as a bimetal circuit breaker. Alternatively, the system may be designed so that a reset signal is generated once the electrical switch used by the operator of the device is returned to the off position.

One embodiment of the present invention is an automated accessory for a spare tire hoist for an automotive vehicle having a direct current power source and a spare tire stored in a horizontal orientation beneath the underside of a vehicle body and including a hoist with a rotatable drive input for raising and lowering said spare tire. The automated assembly includes a bidirectional direct current motor for mounting beneath said underside of said vehicle body proximate said spare tire hoist and having a motor output drive shaft and electrical input leads, speed reduction gearing coupled to said motor output drive shaft and having a gear output drive shaft, a coupler extending from said gear output drive shaft for engagement with said hoist drive input, a load-actuated circuit breaker coupled in circuit with said electrical input leads to said motor and having accessory power leads for connection to said direct current power source of said vehicle, and an actuating electrical switch coupled in circuit with said accessory power leads and located remotely from said motor for alternatively driving said motor in opposite directions and for cutting power to said motor entirely.

In another aspect of the present invention, the hoist drive input is a shaft with a drive-engaging end having a polygonal cross section, and said coupling includes a socket defining a cavity of polygonal cross section that is positioned in seated engagement upon said drive-engaging end.

In another aspect of the present invention, the drive-engaging end and said cavity of said socket both have a square cross section.

In another aspect of the present invention, the hoist drive input is a cylindrical drive tube having diametrically opposed, transverse openings defined therethrough and said coupler includes a rod having a bore defined diametrically therethrough and said rod is disposed within said drive tube, and a transverse pin extends through said diametrically opposed openings in said tube and through said transverse bore in said coupler rod.

In another aspect of the present invention, the automated accessory further includes an accessory case containing said motor with the speed reduction gearing, and the circuit breaker.

In another aspect of the present invention, the load-actuated circuit breaker is a bimetal circuit breaker.

In another embodiment of the present invention, a power driven hoist control is coupled to includes an automotive vehicle having a direct current power source, a vehicle body, a spare tire oriented in a horizontal disposition and stored on the underside of said vehicle body, a spare tire hoist mounted on said underside of said vehicle body for raising and lowering said spare tire and including a rotatable hoist drive input. The power driven hoist control includes a bidirectional direct current motor secured to said underside of said vehicle body in proximity to said hoist drive input and having a rotary motor output shaft, a motor speed reducer connected to said motor output shaft, a hoist drive adapter connected to said motor speed reducer and to said hoist drive input, a load-actuated current interrupter connected to said electrical power inputs of said motor, and a remote motor switch for alternatively operating said motor to rotate said motor shaft in either of two opposite directions of rotation and to shut off current to said motor entirely.

In another aspect of the present invention, the motor speed reducer is comprised of a plurality of gears and pinions.

In another aspect of the present invention, the remote switch is located externally at the rear of said vehicle.

In another aspect of the present invention, the vehicle has an ignition switch within its confines and said remote motor switch is coupled to said direct current power source through said ignition switch.

In another aspect of the present invention, the accessory further includes an accessory housing encapsulating said motor, said motor speed reducer, and said load-actuated current interrupter therewithin.

In another aspect of the present invention, the motor speed reducer has an output drive and said accessory housing defines a hollow enclosure formed by confining walls and said hollow enclosure has a wall opening for said output drive of said motor speed reducer.

In yet another embodiment of the present invention, an automated spare tire hoist accessory used on an automotive vehicle having a direct current power source, a vehicle body that includes a rear deck, a spare tire oriented in a horizontal disposition and stored beneath said rear deck, and a spare tire hoist for raising and lowering said spare tire located beneath said rear deck and having a rotatable hoist drive input. The automated spare tire hoist accessory includes

In another aspect of the present invention, the a bidirectional direct current motor secured beneath said vehicle body proximate said spare tire hoist and having electrical power inputs and a power output shaft, speed reduction gearing connected to said motor power output shaft and having a gear output shaft, a coupling attached to said gear output shaft and to said rotatable hoist drive input, an electrical load-sensitive shut off device coupled in circuit with said electrical power inputs to said motor, and an actuating switch located remote from said motor and alternatively operable to drive said motor output shaft in opposite directions and to shut off current to said motor.

In another aspect of the present invention, the automotive vehicle has an internal electrical ignition switch and said electrical power inputs of said motor are coupled to said direct current power source through said electrical ignition switch.

In another aspect of the present invention, the actuating switch is located at the rear exterior of said vehicle.

In another aspect of the present invention, the automotive vehicle further includes a housing forming an enclosure containing said winch motor, said speed reduction gearing, and said electrical load-sensitive shut-off device.

In one broad aspect the invention may be considered to be an automated accessory for a spare tire hoist for an automotive vehicle of the type having a direct current power source and a spare tire stored in a horizontal orientation beneath the underside of the vehicle body. The vehicle also includes a hoist with a rotatable drive input for raising and lowering the spare tire.

The automated accessory of the invention is preferably comprised of an accessory case secured beneath the underside of the vehicle proximate the spare tire hoist. The accessory also includes a bidirectional direct current motor mounted in the accessory case and having a motor output drive shaft and electrical input leads. Speed reduction gearing is coupled to the motor output drive shaft. The speed reduction gearing has a gear output drive shaft. A coupler extends from the gear output drive shaft for engagement with the hoist rotatable drive input. A load-actuated circuit breaker is located within the accessory case and is coupled in circuit with the electrical input leads to the motor. The circuit breaker has accessory power leads extending from the accessory case for connection to the direct current power source of the vehicle. An actuating electrical switch is coupled in circuit with the accessory power leads and is located remotely from the motor. The actuating switch alternatively drives the motor in opposite directions and is also operable to cut power to the motor entirely. The accessory automatically raises or lowers the vehicle spare tire relative to the underside of the vehicle body, depending upon the position of the actuating switch.

In another aspect the invention may be considered to be an improvement in an automotive vehicle having a direct current power source, a vehicle body, a spare tire oriented in a horizontal disposition and stored on the underside of the vehicle body, a spare tire hoist mounted on the underside of the vehicle body for raising and lowering the spare tire and including a rotatable hoist drive input. The improvement of the invention is comprised of a power-driven hoist control. The hoist control of the invention includes a bidirectional direct current motor secured to the underside of the vehicle body in proximity to the hoist drive input and having a rotary motor output shaft. The hoist control also includes a motor speed reducer connected to the motor output shaft and a hoist drive adapter connected to the motor speed reducer and to the hoist drive input. A load-actuated current interrupter is connected to the electrical power inputs of the motor. A remote motor switch is provided for alternatively operating the motor to rotate the motor shaft in either of two opposite directions of rotation or to shut off current to the motor entirely.

Considered in still another aspect, the invention may be described as an improvement to an automotive vehicle having a direct current power source, a vehicle body that includes a rear deck, a spare tire oriented in a horizontal disposition and stored beneath the rear deck, and a spare tire hoist for raising and lowering the spare tire located beneath the rear deck and having a rotatable hoist drive input.

The improvement of the invention is an automated spare tire hoist accessory. The spare tire hoist accessory of the invention includes a bidirectional direct current motor, speed reduction gearing, a coupling, an electrical load-sensitive shut off device, and an actuating switch. The hoist control preferably includes an accessory housing which is secured beneath the rear deck proximate the spare tire hoist. The bidirectional direct current motor is located within the accessory housing and has electrical power inputs and a motor output shaft. The speed reduction gearing is located within the accessory housing and is connected to the motor output shaft. The speed reduction gearing has a gear output shaft. The coupling is attached to the gear output shaft and to the rotatable hoist drive input. The electrical load-sensitive shut off device is located in the accessory housing and is coupled in circuit with the electrical power inputs to the motor. The actuating switch is located remote from the accessory housing and is alternatively operable to drive the motor output shaft in opposite directions and to shut off current to the motor.

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

Referring now to the drawings in which like reference numbers represent corresponding parts throughout:

FIG. 1 illustrates an example embodiments of an article of manufacture providing a wireless automatic tire winch according to the present invention.

FIG. 2 illustrates a schematic of a circuit providing a wireless automatic tire winch according to the present invention.

FIG. 3 illustrates a preferred embodiment of an article of manufacturer providing a wireless automatic tire winch according to the present invention.

### DETAILED DESCRIPTION

This application relates in general to an article of manufacture for providing personal protective devices, and more specifically, to an article of manufacture providing a leak resistant facemask according to the present invention.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps or components, but do not preclude the presence or addition of one or more other features, steps or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

The terms “driver,” and “user” refer to an entity, e.g., a human, using an article of manufacture providing a wireless automatic tire winch according to the present invention. The term user herein refers to one or more users.

The term “invention” or “present invention” refers to the invention being applied for via the patent application with the title “Automatic Spare Tire Hoist.” Invention may be used interchangeably with tire winch.

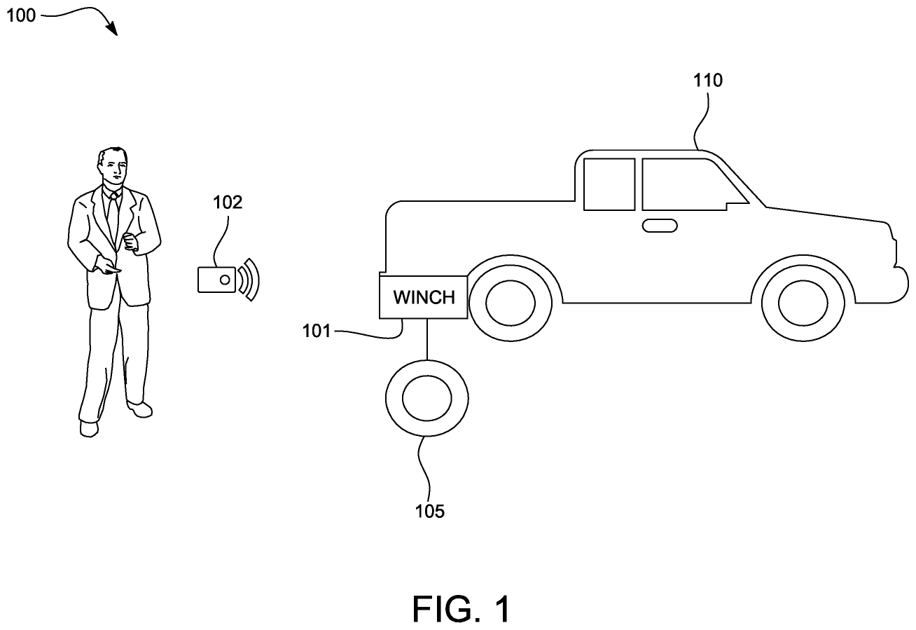

In general, the present disclosure relates an article of manufacture providing a wireless automatic tire winch according to the present invention. To better understand the present invention, FIG. 1 illustrates an example embodiments of an article of manufacture providing a wireless automatic tire winch according to the present invention.

A spare tire 105 is typically stored underneath a bed 104 of a pickup truck or vehicle 110. When a tire needs to be replaced with the spare tire 105, the spare tire 105 must first be lowered from underneath the bed 104 before the tires may be switched. The present invention permits a driver to lower the spare tire 105 while standing away from the vehicle 110. The driver uses a wireless remote device 102 to activate a winch 101 mounted under the vehicle 110 to automatically lower the spare tire 105 to the ground. Once the spare tire 105 is placed onto a wheel hub (not shown), the tire removed from the vehicle 110 may be attached to the winch 101 to raise the tire into a secure storage location.

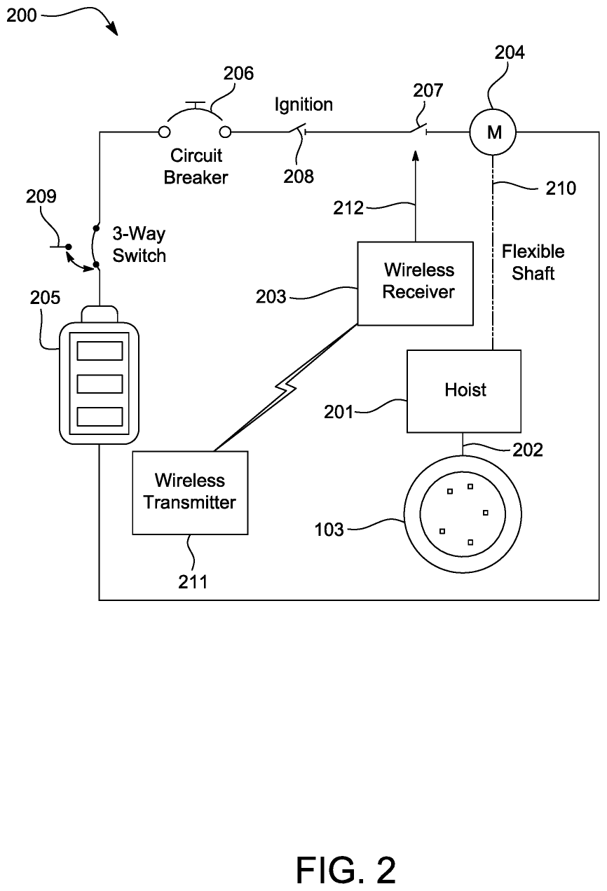

FIG. 2 illustrates a schematic of a circuit providing a wireless automatic tire winch according to the present invention. The automated spare tire hoist accessory 100 of the invention. provides a positive safeguard against overwinding the hoist cable 202. Once the hoist cable 202 has been fully tightened as the spare tire 105 is pulled up against the undersurface of the vehicle 110, the increased resistance increases current to a hoist electric motor 204. Once the current to the hoist electric motor 204 rises to a threshold level, the electrical load-sensitive shut off device cuts off power to the hoist electric motor 204, thereby preventing damage to the hoist electric motor 204 or to the hoist cable 202.

Preferably, the actuating switch is a three-way switch 209 that is externally located at the rear of the vehicle 110. The three way switch 209 permits the hoist 201 to operate either in a manual or an automatic operating mode. Preferably also the automated spare tire hoist accessory 100 a the invention is wired through the vehicle ignition 208, The location a the three-way switch 209 at the rear and on the exterior of the vehicle 110 allows a user to operate the spare tire hoist accessory 100 of the invention while standing at the rear of the vehicle 110. This is the most convenient position for the operator to gain access to the spare tire 105. However, by wiring the hoist electric motor 204 through the ignition switch of the vehicle 110, the system of the invention serves as a theft prevention device so that a thief cannot merely operate the automated spare tire hoist accessory 100 as an aid in stealing the spare tire 105. To the contrary, unless the user has the ignition key and turns it on, the system will remain disabled. Moreover, since the automated spare tire hoist accessory coupling is attached to the rotatable hoist drive input, a thief cannot gain access to the hoist operating mechanism to manually lower the hoist. The automated spare tire hoist accessory 100 of the invention thereby serves as a very effective spare tire antitheft device.

Another very advantageous feature of the invention is its retrofit capability. The automated spare tire hoist accessory 100 can be mounted on the undercarriage of a vehicle 110 to convert a conventional manual spare tire hoist to a power-driven spare tire hoist. The automated spare tire hoist accessory 100 is easily installed by anyone having basic mechanical and electrical wiring skills.

A conventional manual vehicle spare tire hoist system 201 of the type often installed as original equipment on a pickup truck, a sport utility vehicle, or a van is hereby described. The conventional, manual hoist 201 is mounted on the underside of the rear deck at the undercarriage of an automotive vehicle. The manual hoist 201 has a hoist housing with base feet or flanges and that are bolted or otherwise secured by conventional means to the underside of the deck beneath which the hoist is located.

The conventional, manually operated spare tire hoist 201 includes a reel having disc-shaped end plates and at opposite ends of a cylindrical drum upon which a hoist cable is wound. The hoist cable 202 is typically a stranded wire cable, one end of which is anchored to the drum, and the other end of which is coupled to a grappling bar. The hoist cable 202 passes through a hole in the bottom plate of the tire hoist housing. The hole in the plate is typically lined with an annular plastic bushing to avoid metal to metal contact between the hoist cable 202 and the spare tire hoist housing.

The reel has an axis of rotation that is aligned relative to the vehicle in a fore and aft direction at the undersurface of the vehicle. At one of its ends the drum has a central axle well that receives a stub axle that passes through an opening in the forward upright wall of the hoist cable housing. At its opposite end, the cable drum has a cylindrical axle shaft that extends in an art direction outwardly through an opening in the opposite rear wall of the cable housing. A connecting stud is secured to the end of the axle shaft that protrudes outwardly through the rear housing wall. The connecting stud has a polygonal cross section. In a Chevrolet pickup truck, for example, the base of the stud adjacent the rear wall is three-eighths inches square and the longitudinally aft facing end of the cap is wedged down to a slightly smaller cross section.

In the original installation in the vehicle the end of the Z-handle jack crank or L-shaped tire iron that is used to operate the vehicle tire jack supplied as standard equipment with the vehicle is engaged with the end of the coupling rod protruding through an opening in the bumper. The jack handle crank is rotated in a direction that winds the cable onto or reels it off of the drum. With the hoist 201 cable extended out of the housing, the grappling bar is tilted so that it can be inserted through the axle opening in the center of the hub of the spare tire of the vehicle. The grappling bar is then reoriented so that its ends engage the underside of the hub of the spare tire 105. By cranking in one direction of rotation on the stud the spare tire is drawn upwardly until its hub seats against the bottom plate of the hoist housing. The operator can tell by the resistance felt when the spare tire has been fully drawn up against the hoist housing.

To lower the spare tire, the Z-handle crank or L-shaped tire iron is rotated in the opposite direction, thereby rotating the connecting stud in the opposite direction. The cable is thereupon reeled off of the drum of the reel to lower the spare tire to the ground.

It should be noted that the operation of the conventional, manual spare tire hoist 201 can be performed by any individual having an appropriate Z-handle crank or L-shaped tire iron. Thus, there is nothing to prevent a thief from operating the manual spare tire hoist and stealing the spare tire from a vehicle parked in an unattended parking lot or from a vehicle parked on the street.

A bidirectional direct current hoist electric motor 204 coupled to the underside of the vehicle 110. The hoist electric motor 204 has attachment flanges that are secured by bolts to vehicle 110. The hoist electric motor 204 has electrical power input wires and a flexible motor output shaft 210.

The automated spare tire hoist accessory 100 also includes speed reduction gearing coupled between the hoist electric motor 204 and a control input to the existing manual hoist 201. Different types of speed reduction gearing may be employed, but in the preferred embodiment of the invention the speed reduction gearing is comprised of a cluster of spur gears and pinions that terminate in a gear output shaft that extends forwardly through the opposite forward end wall of the metal enclosure opposite the wall upon which the hoist electric motor 204 is mounted. The hoist electric motor 204 at normal operation draws a current of 7.2 amperes to rotate the gear output shaft at 70 rpm.

A hoist drive adapter in the form of a coupler is attached to a flexible gear output shaft 210 and to the rotatable hoist drive input connector stud. The coupler is comprised of a rod, one end of which receives the exposed end of the gear output shaft and is secured thereto by a set screw. A socket is secured to the other end of the rod. The socket defines within its structure a cavity having a square cross section adapted to receive the connector stud at the end of the axle shaft snugly therewithin.

The spare tire hoist accessory 100 also includes an electrical load-sensitive shut off device, which in the preferred embodiment of the invention is a bimetal circuit breaker 206. The circuit breaker 206 is located in the accessory housing and is coupled in circuit with the electrical power inputs to the hoist electric motor 204. When the hoist electric motor 204 reaches a stall condition as the spare tire is drawn up against the bottom plate of the spare tire hoist housing, the bimetal circuit breaker 206 heats up and breaks the power connection to the electrical power inputs to the hoist electric motor 204. This shuts off the hoist electric motor 204 without damaging it. With the interruption of power, the bimetal circuit breaker 206 cools, thereby resetting itself.

The adapter housing forms an accessory mount defining a hollow enclosure formed by confining walls that encapsulate the hoist electric motor 204, the speed reducing gearing, and the load-actuated current interrupter, namely the bimetal circuit breaker 206 therewithin. The housing has a wall opening for the output drive shaft of the speed reducing gearing.

The automated spare tire hoist accessory 100 also includes an enabling three position switch 209, which is preferably a rocker switch 209. The three position switch 209 is located remote from the accessory housing and is preferably positioned in the opening in the bumper originally provided to receive the manually operable coupling connector provided as original equipment for the spare tire hoist. The appropriate one of a plurality of inexpensive, plastic adapters designed for each different size and shape of different openings in the vehicle bumpers of different vehicles is utilized to ensure that the switch is firmly mounted in the vehicle rear bumper opening. The remote switch is thereby located externally at the rear of the vehicle. The enabling switch is alternatively operable to drive the motor output shaft in either of two opposite directions of rotation, or to shut off current to the motor entirely.

The vehicle 110 with which the automated spare tire hoist accessory 100 is used has an enclosed cab with a dashboard or steering wheel column having with an ignition switch 208 mounted therein. Also, the three position switch 209 is coupled to the direct current power source 205 of the vehicle 110, specifically the lead acid storage battery 205, through the vehicle ignition 208. Consequently, unless a vehicle ignition key has been used to enable the ignition switch, no current will flow to the hoist electric motor 204. That is, electrical current will flow to the line and on to line, which is coupled to the positive terminal of the rocker switch, only when the ignition key has been used to activate the vehicle ignition 208. As a consequence, even if the three position switch 209 is pressed in the direction to operate the automated spare tire hoist accessory 100 to lower the spare tire 105, hoist electric motor 204 will not operate unless the ignition switch 208 has been actuated. This feature of the invention serves as a theft prevention device to safeguard the spare tire.

Once the ignition switch 208 is actuated by the key, however, operation of the rocker switch 209 in either of two opposite directions from a null position will provide an electrical current flow to the hoist electric motor 204. A wireless receiver 202 provides the electric hoist motor 204 with a directional signal 212 to indicate the direction of rotation of the electric hoist motor 204, and thus the flexible rod 303 and the control input to the spare tire hoist 301. The directional signal 212 may be directly input into the electric hoist motor 204 when the motor itself is so configured. Alternatively, the direction& signal 212 may be coupled to a motor enable switch 207 to flip the polarity of the inputs to the electric hoist motor 204 to rotate in opposite directions.

Undoubtedly, numerous variations and modifications of the invention will become readily apparent to those familiar with vehicle spare tire hoists. For example, different models of vehicles have different configurations for the rotatable hoist drive input. In a Dodge pickup truck, for example, the hoist drive input is not a square, male stud, like the connecting stud, but rather a hollow, steel female tube ‘having a pair of diametrically opposed holes therethrough. The coupler or adapter therefore must have a different configuration to engage the hollow spare tire hoist drive input tube.’ For this connection, the adapter or coupler extending between the gear output drive shaft and the hollow tube ‘is a solid rod ’ having a bore defined diametrically therethrough. The transverse bore through the rod ‘is of a size and is at a location to align with the corresponding diametrically opposed apertures in the tube.’ A cotter pin is then used to engage the end of the rod ‘with the hoist drive input tube.’

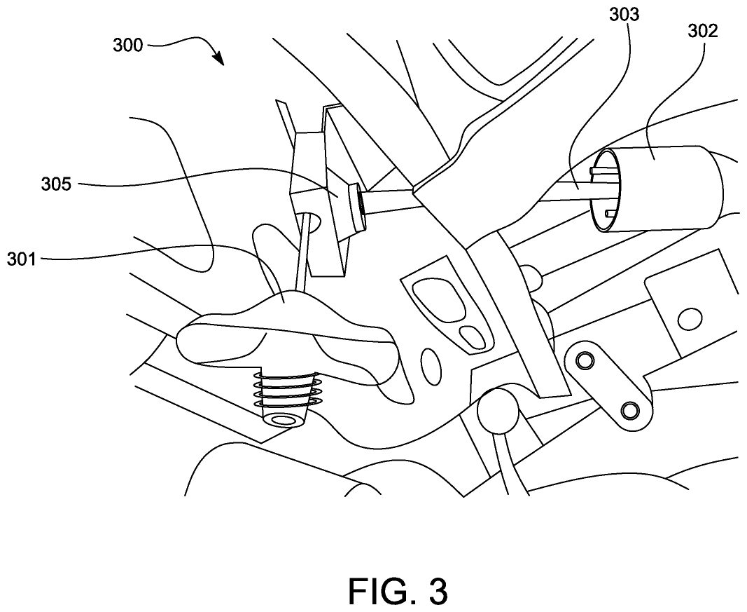

FIG. 3 illustrates a preferred embodiment of an article of manufacturer providing a wireless automatic tire winch according to the present invention. The present invention uses a DC motor 302 that attaches to the existing manual spare tire hoist 301 with a flexible rod 303 shaft located between the DC motor 302 and the manual spare tire hoist 301 as shown in FIG. 3. The flexible rod 303 will be about 10 to 1.2 inches or so that lowers the spare tire down. The DC motor 302 will be mounted on the bottom undercarriage of the truck bed with two bolts holding the DC motor 302 in place. In this embodiment, the driver may upgrade from a manual spare tire hoist to an automatic spare tire hoist 300 basically the motor with the rod shaft can attach to an existing manual spare tire hoist 301 and making it an automatic hoist. When in the automatic mode, the wireless receiver 203 receives a signal from a wireless transmitter 211 to activate the hoist motor 302. As the hoist motor 302 rotates, the flexible rod 303 coupled to the motor shaft also rotates. As the flexible rod 303 is coupled to a control input to the spare tire hoist 301, the rotation of the flexible rod 303 causes the spare tire hoist 301 to raise or lower the spare tire 105.

Other vehicles have different configurations for their rotatable hoist drive inputs. An adapter having an appropriate mating configuration is therefore provided to match the corresponding hoist drive input configuration of the model of the vehicle involved. Accordingly, the scope of the invention should not be construed as limited to the specific embodiments depicted and described, but rather is defined in the claims appended hereto.

Even though particular combinations of features are recited in the present application, these combinations are not intended to limit the disclosure of the invention. In fact, many of these features may be combined in ways not specifically recited in this application. In other words, any of the features mentioned in this application may be included to this new invention in any combination or combinations to allow the functionality required for the desired operations.

No element, act, or instruction used in the present application should be construed as critical or essential to the invention unless explicitly described as such. Further, the phrase “based on” is intended to mean “based, at least in part, on” unless explicitly stated otherwise.

What is claimed is:

1. An automated accessory for a spare tire hoist for an automotive vehicle having a direct current power source and a spare tire stored in a horizontal orientation beneath the underside of a vehicle body and including a hoist with a rotatable drive input for raising and lowering said spare tire comprising:
a bidirectional direct current motor for mounting beneath said underside of said vehicle body proximate said spare tire hoist and having a motor output drive shaft and electrical input leads;
speed reduction gearing coupled to said motor output drive shaft and having a gear output drive shaft;
a coupler extending from said gear output drive shaft for engagement with said hoist drive input;
a load-actuated circuit breaker coupled in circuit with said electrical input leads to said motor and having accessory power leads for connection to said direct current power source of said vehicle; and
an actuating electrical switch coupled in circuit with said accessory power leads and located remotely from said motor for alternatively driving said motor in opposite directions and for cutting power to said motor entirely.

2. An automated accessory according to claim 1, wherein said hoist drive input is a shaft with a drive-engaging end having a polygonal cross section, and said coupling includes a socket defining a cavity of polygonal cross section that is positioned in seated engagement upon said drive-engaging end.

3. An automated accessory according to claim 2 wherein said drive-engaging end and said cavity of said socket both have a square cross section.

4. An automated accessory according to claim 1 wherein said hoist drive input is a cylindrical drive tube having diametrically opposed, transverse openings defined therethrough and said coupler includes a rod having a bore defined diametrically therethrough and said rod is disposed within said drive tube, and a transverse pin extends through said diametrically opposed openings in said tube and through said transverse bore in said coupler rod.

5. An automated accessory according to claim 1 further comprising an accessory case containing said motor, said speed reduction gearing, and said circuit breaker.

6. An automated accessory according to claim 1 wherein said load-actuated circuit breaker is a bimetal circuit breaker.

7. In an automotive vehicle having a direct current power source, a vehicle body, a spare tire oriented in a horizontal disposition and stored on the underside of said vehicle body, a spare tire hoist mounted on said underside of said vehicle body for raising and lowering said spare tire and including a rotatable hoist drive input, the improvement comprising a power driven hoist control including:
a bidirectional direct current motor secured to said underside of said vehicle body in proximity to said hoist drive input and having a rotary motor output shaft;
a motor speed reducer connected to said motor output shaft;
a hoist drive adapter connected to said motor speed reducer and to said hoist drive input;
a load-actuated current interrupter connected to said electrical power inputs of said motor; and
a remote motor switch for alternatively operating said motor to rotate said motor shaft in either of two opposite directions of rotation and to shut off current to said motor entirely.

8. An automotive vehicle according to claim 7 wherein said motor speed reducer is comprised of a plurality of gears and pinions.

9. An automotive vehicle according to claim 7 wherein said remote switch is located externally at the rear of said vehicle.

10. An automotive vehicle according to claim 9 wherein said vehicle has an ignition switch within its confines and said remote motor switch is coupled to said direct current power source through said ignition switch.

11. An automotive vehicle according to claim 7 wherein said load-actuated current interrupter is a bimetal circuit breaker.

12. An automotive vehicle according to claim 7 further comprising an accessory housing encapsulating said motor, said motor speed reducer, and said load-actuated current interrupter therewithin.

13. An automotive vehicle according to claim 12 wherein said motor speed reducer has an output drive and said accessory housing defines a hollow enclosure formed by confining walls and said hollow enclosure has a wall opening for said output drive of said motor speed reducer.

14. In an automotive vehicle having a direct current power source, a vehicle body that includes a rear deck, a spare tire oriented in a horizontal disposition and stored beneath said rear deck, and a spare tire hoist for raising and lowering said spare tire located beneath said rear deck and having a rotatable hoist drive input, the improvement comprising an automated spare tire hoist accessory including:
a bidirectional direct current motor secured beneath said vehicle body proximate said spare tire hoist and having electrical power inputs and a power output shaft, speed reduction gearing connected to said motor power output shaft and having a gear output shaft;
a coupling attached to said gear output shaft and to said rotatable hoist drive input; an electrical load-sensitive shut off device coupled in circuit with said electrical power inputs to said motor; and
an actuating switch located remote from said motor and alternatively operable to drive said motor output shaft in opposite directions and to shut off current to said motor.

15. An automotive vehicle according to claim 14 wherein said automotive vehicle has an internal electrical ignition switch and said electrical power inputs of said motor are coupled to said direct current power source through said electrical ignition switch.

16. An automotive vehicle according to claim 15 wherein said actuating switch is located at the rear exterior of said vehicle.

17. An automotive vehicle according to claim 12 further comprising a housing forming an enclosure containing said motor, said speed reduction gearing, and said electrical load-sensitive shut-off device.

18. An automotive vehicle according to claim 14 wherein said load-sensitive shut-off device is a bimetal circuit breaker.
